(19) United States
(12) Patent Application Publication
(10) Pub. No.: US 2005/0222483 A1
(43) Pub. Date: Oct. 6, 2005

(54) Method for treatment of lead-containing surface coatings

(76) Inventor: Randall L. Williams, Charlotte, NC (US)

Correspondence Address: Schwartz Law Firm, P.C.;SouthPark Towers, Suite 530, 6100 Fairview Road, Charlotte, NC, 28210, US

(21) Appl. No.: 10/817,360

(22) Filed: Apr. 2, 2004

(51) Int. Cl. A62D 3/00

(52) U.S. Cl. 588/315

(57) ABSTRACT

A method is provided for treating a lead-containing surface coating on a substrate. The method includes the steps of applying chemicals to the substrate in successive stages. The chemicals include glacial acetic acid, hydrogen peroxide, nitric acid, and ammonium hydroxide. After application, the chemicals remain on the substrate for a thermochemical leaching period, whereby a resulting chemical reaction removes lead ions from the substrate.

### TECHNICAL FIELD AND BACKGROUND OF THE INVENTION

This invention relates to a method of treating surface coatings on substrates that are contaminated with lead-based and lead-containing materials. In particular, this invention provides a method for treating these surfaces so that they are no longer hazardous to humans. The method of the invention can also be used to treat contaminated surface soil.

Lead has long been recognized as a harmful environmental pollutant. Most homes built before 1960 contain heavily leaded paint. Some homes built as recently as 1978 may also contain lead paint. This paint could be on window frames, walls, the outside of homes, or other surfaces. Lead-based paint may contain such compounds as lead chromate, lead molybdenite, lead sulfate, lead borate, lead carbonate, lead monoxide, lead tetroxide, lead vanadate and lead antimonate. Soil very close to homes may also be contaminated with tetraethyl lead and perhaps other lead compounds.

In late 1991, the Secretary of the Department of Health and Human Services called lead the “number one environmental threat to the health of children in the United States.” There are many ways in which humans are exposed to lead: through air, drinking water, food, contaminated soil, deteriorating paint, and dust. Airborne lead enters the body when an individual breathes or swallows lead particles or dust once it has settled. Before it was known how harmful lead could be, it was used in paint, gasoline, water pipes, and many other products. You might have lead in and around your home without knowing it because you cannot see, taste or smell lead. Because lead does not break down naturally it can remain a problem until removed. The greatest threat is breathing or ingesting dust from lead-based paint as it wears and disintegrates over time.

Lead affects practically all systems within the body. Lead at high levels (lead levels at or above 80 micrograms per deciliter of blood) can cause convulsions, coma, and even death. Lower levels of lead can cause adverse health effects on the central nervous system, kidney, and blood cells. Blood lead levels as low as 10 micrograms per deciliter can impair mental and physical development. The effects of lead exposure on fetuses and young children can also be severe. They include delays in physical and mental development, lower IQ levels, shortened attention spans, and increased behavioral problems. Fetuses, infants, and children are more vulnerable to lead exposure than adults since lead is more easily absorbed into growing bodies, and the tissues of small children are more sensitive to the damaging effects of lead. Children may have higher exposures since they are more likely to get lead dust on their hands and then put their fingers or other lead-contaminated objects into their mouths.

Old lead-based paint is the most significant source of lead exposure in the U.S. today. Harmful exposures to lead can be created when lead-based paint is improperly removed from surfaces by dry scraping, sanding, or open-flame burning. High concentrations of airborne lead particles in homes can also result from lead dust from outdoor sources, including contaminated soil tracked inside, and use of lead in certain indoor activities such as soldering and stained-glass making.

Measures to permanently eliminate lead dust hazards include component removal and replacement, paint removal, and covering surfaces. There is no completely safe method for do-it-yourself removal of lead-based paint. Each paint removal method—sandpaper, scrapers, chemicals, and heat guns-can produce lead fumes or dust in the air that can be inhaled. Dust can settle on floors, walls and tables. It can be ingested through hand-to-mouth contact and re-enter the air through cleaning (such as sweeping or vacuuming) or when people move throughout the house.

Lead paint in good condition is usually not a problem except in places where painted surfaces rub against each other and create dust (for example, opening a window). Individuals have been poisoned by scraping or sanding lead paint because these activities generate large amounts of lead dust.

Except for the most elementary measures, dealing with lead removal is a complex task. Implementation may be affected by local regulations. In most instances, lead-based paint should be removed by professionals who follow detailed procedures to minimize, control and contain lead dust created by the removal process. Do not attempt to remove more than a small amount of lead-based paint. However, address all chipping, peeling, or flaking lead-based paint, as well as friction surfaces (for example windows and doors) in the home.

It often is much safer, and sometimes more economical, to replace painted items and cover painted surfaces. You can replace a door, molding, or other item yourself if it can be easily removed without creating lead dust. Cover walls and ceilings with gypsum wallboard, plaster, or paneling (encapsulation). If it is necessary to strip lead-based paint to maintain historic integrity, remove the item (for example molding) from the home for stripping. If the painted surface is not peeling or cracking, you can spray the surface with a sealant. Painting over lead-based paint is not a permanent solution.

Present state-of-the-art procedures for removing lead-based paint have serious disadvantages. The procedure described in U.S. Pat. No. 4,426,250 uses very caustic chemicals such as hydroxides of sodium, potassium, calcium and magnesium. A paste containing such chemicals is applied to the painted surface and is then covered with a fabric during at least part of the treatment period. The method is time consuming and relatively hazardous.

In recent years, the most commonly used paint stripping compositions have contained halogenated hydrocarbon chemicals, such as methylene chloride. Since such chemicals are suspected to be carcinogenic, there have been many attempts to replace them with combinations of other organic chemicals. U.S. Pat. No. 5,089,164 is one reference which describes paint stripping compositions which contain among other organic constituents a significant amount of N-methyl-pyrrolidone. It is believed that these compositions have significantly lower stripping rates than compositions containing methylene chloride, and that organic stripping agents are not easily washed from the stripped surface.

Some stripping compositions have contained peroxides such as those described in U.S. Pat. No. 3,355,385. Theses compositions, however, contain very volatile and flammable solvents which render the life of the composition as a stripping agent very short. U.S. Pat. No. 5,215,675 combines the use of hydrogen peroxide with water soluble esters in aqueous stripping compositions to eliminated such problems.

All of the above stripping compositions contain organic solvents and stripping agents which are not easily washed from the treated surface. Also, none of these references indicate that the compositions are useful for the stripping of lead-based paints.

Treatment of lead in soil has been limited in the prior art to immobilizing the lead by converting lead containing compounds to non-leachable forms. Examples of such immobilization are shown in U.S. Pat. No. 5,162,600, U.S. Pat. No. 5,202,033 and U.S. Pat. No. 5,234,485.

In an effort to overcome the foregoing deficiencies, the composition of U.S. Pat. No. 5,741,366 was developed which comprises an aqueous mixture of hydrogen peroxide, ammonium hydroxide, nitric acid and acetic acid. That composition is poured onto the surface to be treated to remove the lead based paint. Use of the product, however, still does not result in effective lead abatement.

The heretofore available lead abatement processes suffer from a number of additional drawbacks. In particular, these methods and compositions are usually highly labor intensive, and often result in production rates of only minimal square feet of abatement per man hour. The abatement materials themselves are generally expensive and coupling the with the high cost of disposal of the waste material, adds an additional drawback to the prior procedures. Other considerations that increase the cost of these prior methods are the inability of the materials and methods to protect against lead migration into the substrate pores, which oftentimes inhibits total lead removal and ultimately necessitates a coating over the substrate to prohibit the lead deep in the pores from reaching the substrate surface.

### SUMMARY OF INVENTION

Therefore, it is an object of the invention to provide a safe and effective method of removing lead-based and lead-containing materials, such as lead-based paint, from substrates, such as metal, wood, sheet rock, plaster and concrete.

It is an additional object of the invention to remove the lead-based and lead-containing materials by the simple multi-stage application of a limited number of treatment materials.

It is also an object of the invention to provide a method for the abatement of lead contaminated surface soil.

It is a further object of the invention to provide a process whereby the rinse water used to remove the lead treatment materials from the substrate can be neutralized for safe disposal.

It is yet another object of the invention to provide a method of lead abatement that is more economical in terms of the materials used as well as in the savings of time to complete the effective abatement.

It is also an object of the invention to provide a method whereby the efficiency of the lead removal is enhanced by greatly reducing the migration of the lead into the substrate pores.

Still further, it is an object of the invention to provide economy in the disposal of the waste materials using the filtration process of the invention.

These and other objects of the present invention are achieved in the preferred embodiments disclosed below by providing a method for treating a lead-containing surface coating on a substrate. The method includes the steps of applying chemicals to the substrate in successive stages. The chemicals include glacial acetic acid, hydrogen peroxide, nitric acid, and ammonium hydroxide. After application, the chemicals remain on the substrate for a thermochemical leaching period, whereby a resulting chemical reaction removes lead ions from the substrate.

The term “substrate” is defined broadly herein to mean any base or surface upon which or within which a material is applied or resides.

According to another preferred embodiment of the invention, the chemicals are applied by means selected from the group consisting of brushing, spraying, and dipping.

According to another preferred embodiment of the invention, the method includes allowing a chemical dwell time between each successive stage of chemical application to the substrate.

According to another preferred embodiment of the invention, the dwell time is between 30 seconds and 3 minutes.

Preferably, the concentration of glacial acetic acid is within a range of 99% to 175% v/v.

Preferably, the concentration of hydrogen peroxide is within a range of 50% to 70% v/v.

Preferably, the concentration of nitric acid is within a range of 68% to 85% v/v.

Preferably, the concentration of ammonium hydroxide is within a range of 28% to 50% v/v.

According to another preferred embodiment of the invention, the method includes rinsing the chemicals from the substrate with water after the thermochemical leaching period.

According to another preferred embodiment of the invention, the method includes neutralizing the rinse water prior to disposal.

In another embodiment, the invention is a method for treating a lead-containing surface coating on a substrate. The method includes the steps of applying chemicals to the substrate in successive stages. These stages comprise a first stage application of glacial acetic acid, a second stage application of hydrogen peroxide, a third stage application of nitric acid, and a fourth stage application of ammonium hydroxide. After application, the chemicals remain on the substrate for a thermochemical leaching period, whereby a resulting chemical reaction removes lead ions from the substrate.

In yet another embodiment, the invention is a method for treating lead-contaminated soil. The method includes first aerating the soil, and then applying chemicals to the aerated soil in successive stages. The chemicals include glacial acetic acid, hydrogen peroxide, nitric acid, and ammonium hydroxide. After application, the chemicals remain on the soil for a thermochemical leaching period, whereby a resulting chemical reaction removes lead ions from the soil.

### DESCRIPTION OF THE PREFERRED EMBODIMENT AND BEST MODE

The method of the present invention comprises a series of consecutive steps by which it is possible to remove hazardous lead from many different types of substrates and surfaces, for example painted wood surfaces, plaster, wallboard, metal, concrete and brick. In this method, different chemicals are applied separately in four successive stages followed by a final aqueous rinse. The application of the chemicals to the substrates may be by brush, by spraying, by dipping or any other convenient means.

The first stage of the process is the application glacial acetic acid to the material containing the lead-based or lead-containing coating. The second stage is the application of hydrogen peroxide to the surface previously treated with the glacial acetic acid. The third stage is the application of concentrated nitric acid following the application of the hydrogen peroxide. The fourth stage is the application of ammonium hydroxide following the application of concentrated nitric acid. Preferably, at least three minutes is allowed between each stage of the process such that each of the chemical applications has sufficient time to work effectively; however, the process has been shown to work effectively even when the elapsed time between each stage is less than a minute, e.g. 30 seconds or more. The period between stages is referred to herein as the “chemical dwell time.”

The glacial acetic acid is generally within the range of concentrations from 175.00% to 99.7% v/v, essentially pure glacial acetic acid. In the preferred embodiment, pure (99.7%) glacial acetic acid is desired. The acceptable range of concentration for the hydrogen peroxide application is from between 50% to 70% v/v hydrogen peroxide, with 50% hydrogen peroxide being the preferred concentration. The third chemical application of nitric acid is concentrated nitric acid in the range of 68.0% to 85% v/v, with 68-70% concentration being preferred. Finally, the last application of ammonium hydroxide has a concentration ranging from 28% to 50% v/v ammonium hydroxide, with 28.0-30.0% ammonium hydroxide being the preferred concentration.

After all four of the chemical applications have been completed, the chemicals are allowed to remain on the substrate for an optimal residence time—anywhere from three to twelve hours. The residence time defines a thermochemical leaching period within which a resulting chemical reaction effects removal of the lead ions by a thermochemical leaching process. The residence time that the chemicals remain on the surface on the substrate varies with the number of layers of lead-containing surface coatings and the nature of the substrate. For example, when there are multiple layers of lead-containing coatings, the residence time will most likely be longer than for a single layer. Likewise, the residence time can also be longer on porous substrates than on less porous substrates. Each situation of lead treatment can be expected to have its own parameters. In order to determine the optimum residence time for a particular coated substrate, a sample test location can be pre-treated and tested in order to determine the timing necessary to complete treatment of the entire surface or substrate. The exact volume of chemicals applied at each stage will also vary based on a number of factors, such as those mentioned above.

Following the desired residence time, the chemicals are rinsed from the substrate with a clean rinse water. The rinse water containing any removed residue, chemicals and lead is collected and neutralized, preferably pursuant to the method set forth below.

At the end of the desired residence time, the surface of the substrate is rinsed and is tested, for example by a spectrum analyzer X-ray fluorescence detector (XRF) to determine whether there is lead remaining, and if so, whether further treatment or longer residence time is necessary to obtain the desired safe range of lead remaining on the substrate.

The waste rinse water from rinsing treating chemicals from the substrate should be collected and treated prior to disposal so that it is not hazardous to the environment. This treatment can be accomplished according to the following procedure.

The waste rinse water is collected and stored in a first container, such as a 55 gallon drum, where it is diluted 3:1 with clean water, i.e., the drum is filled three quarters full with waste rinse water and one-quarter full with clean water. The first container is agitated to mix the rinse water and clean water. The diluted waste rinse water is transferred (e.g., pumped) to a second container, such as a second 55 gallon drum, where solid particles in the waste rinse water are allowed to settle out of the diluted waste rinse water solution. From the second container, the diluted rinse water is removed (e.g., pumped off) and the remaining settled solids are removed for disposal or recycling. The diluted rinse water removed from the second container is transferred to a third container, e.g., a third 55 gallon drum, so that the third container is approximately one-half full. In this third container, the diluted waste rinse water is tested for pH, and the pH is adjusted to 7 by using baking soda. Preferably, the baking soda is added to the waste rinse water using a commercially available injection system in order to maintain the pH at least 7. Once a pH of 7 is attained in the diluted waste rinse water in the third container, the rinse water is passed through a charcoal filtration system in order to remove any remaining lead in the waste rinse water. A three-stage charcoal filtration technique has proven effective where the pH-adjusted waste rinse water is passed through three successive filters, namely in order of 50, 20 and 5 micron charcoal filters. If necessary, even a fourth 2 micron filter may be added. After passing through the charcoal filtration, the waste water is tested again using a TCLP (Toxicity Characteristic Leaching Process) analysis to ensure that sufficient lead and chemicals have been removed from the water to meet recognized governmental standards for lead and chemical levels in effluent for safe disposal in any sewage or drainage system. Also, pH samples are taken to ensure that proper pH levels are maintained before disposing of the filtered effluent. Eventually, the lead collected by the charcoal filters may also be recovered and disposed of in an approved recycling facility.

The foregoing method of lead removal from a substrate can also be modified to treat lead contaminated soil to depths of three to six inches in order to reduce levels of lead content in soils to safe and acceptable limits.

In the process of soil treatment, the soil is initially aerated (for example by treating the soil with pavement spikes) to provide openings in the soil. Following aeration, the first stage application of glacial acetic acid (preferably in the range of 99.7% v/v concentrated acetic acid) is applied (e.g., by spraying) onto the soil in an amount sufficient to penetrate into the soil. The second stage is the application (e.g., by spraying) the hydrogen peroxide onto the soil. Again, preferably, the hydrogen peroxide is 50% v/v hydrogen peroxide. After allowing the hydrogen peroxide to penetrate into the soil, the third stage of nitric acid (preferably 68-70% v/v nitric acid) is applied to the soil (e.g., by spraying). Once the nitric acid has penetrated into the soil for the desired period of time, the fourth stage of ammonium hydroxide (e.g., 28.0-30.0% v/v ammonium hydroxide) is applied (again, for example, by spraying). In each instance, the chemicals used are the same chemicals, i.e., acetic acid, hydrogen peroxide, nitric acid and ammonium hydroxide as set forth in the process for treating a solid surface or substrate, and the variable range of concentrations is the same as discussed previously.

In the preferred embodiment, the desired period of time between each of the chemical application stages is approximately one hour although times as short as twenty minutes have been effective. This will allow each chemical sufficient dwell time to penetrate into the soil before the application of the next stage chemical. The penetration time will vary with the density of the soil.

Like the described treatment of a substrate by the application of the chemicals in the various stages wherein following the application of the ammonium hydroxide the chemicals are allowed to remain on the substrate for a desired residence time in order to allow the thermochemical leaching process to leach the lead ions out of the pores of the substrate through the paint layer, in the soil treatment process, the chemicals are also allowed to remain in the soil for a period of from less than one to three hours after the application of the ammonium hydroxide in order to permit complete ionization of the contaminate lead. Thereafter, the soil is saturated with sufficient rinse water (such as by applying a water spray thereto) in order to neutralize the treating chemicals.

Seventy-two hours after the application of the rinse water, the soil is again tested for lead contamination. If the testing indicates that the lead contamination has been eradicated, the soil is once again sprayed with water to make sure the treated surfaces are clean. Follow up testing may also be conducted within thirty days by taking core samples of the treated soils areas and subjecting them to further lead and chemical analysis to assure that the soil is clear of contaminants.

The method of the present invention was used to treat lead-contaminated substrates and soil as shown in the following examples. These examples are meant to be illustrative of the use of the method of the invention, and are not to be considered restrictive in any way.

### EXAMPLE 1

In the first example, a wooden substrate with a paint coating having a thickness of 10 mil was treated by the stagewise process of the invention. An initial XRF reading was taken using a MAP 4 spectrum analyzer prior to treatment and indicated a reading of 8.89 μg/cm². A first stage application of 99.7% v/v glacial acetic acid was sprayed onto the painted surface. Shortly thereafter, i.e., less than one minute later, a second stage application of 50% v/v hydrogen peroxide was sprayed onto the substrate. Less than one minute later, 68%-70% v/v nitric acid was sprayed onto the substrate, followed less than a minute thereafter by the application of 28.0%-30.0% v/v ammonium hydroxide. After the application of the ammonium hydroxide, the chemicals were allowed to remain on the substrate for approximately three hours before rinsing, i.e., spraying, the substrate with clean water and wiping the surface with a water dampened cloth. A second XRF reading following the rinsing and wiping was performed and revealed a reading of −0.08 μg/cm². (A reading of 1.00 μg/cm² or less for a wood substrate is an indication of safe removal of the lead contaminant.)

### EXAMPLE 2

In the second example, a metal substrate with a paint coating having a thickness of 3 mil was treated by the stagewise process of the invention. An initial XRF reading was taken using a MAP 4 spectrum analyzer prior to treatment and indicated a reading of 5.62 μg/cm². A first stage application of 99.7% v/v glacial acetic acid was sprayed onto the painted surface. Shortly thereafter, i.e., less than one minute later, a second stage application of 50% v/v hydrogen peroxide was sprayed onto the substrate. Less than one minute after the application of the hydrogen peroxide, 68%-70% v/v nitric acid was sprayed onto the substrate, followed less than a minute later with spraying 28.0%-30.0% v/v ammonium hydroxide onto the surface. After the application of the ammonium hydroxide, the chemicals were allowed to remain on the substrate for approximately three hours before rinsing, i.e., spraying the substrate, with clean water and wiping the surface with a water dampened cloth. A second XRF reading following the rinsing and wiping was performed and revealed a reading of −0.27 μg/cm². (A reading of 1.00 μg/cm² or less for a metal substrate being an indication of safe removal of the lead contaminant.)

### EXAMPLE 3

In the third example, a contaminated soil sample was treated by the stagewise process of the invention. An initial XRF reading of the soil was taken using a MAP 4 spectrum analyzer prior to treatment and indicated a reading of 742 μg/ft². A first stage application fo 99.7% v/v glacial acetic acid was sprayed onto the surface of an area of aerated soil. Shortly thereafter, i.e., less than one minute later, a second stage application of 50% v/v hydrogen peroxide was sprayed onto the soil. Less than one minute after the application of the hydrogen peroxide, 68%-70% v/v nitric acid was sprayed onto the soil, followed less than one minute later by the application fo 28.0%-30.0% v/v ammonium hydroxide. Following the application of the ammonium hydroxide, the chemicals were allowed to remain in the soil for approximately one hour before being saturated i.e., sprayed, with clean water. A second XRF reading following the saturation with clean water revealed a reading of −187 μg/ft². (A reading of 400 μg/ft² or less in a surface soil sample being an indication of safe neutralization of the lead contaminant.)

During the process of treating the various substrate materials it is recommended that care be taken to insure the physical safety of the workers using the various described chemicals not only from contact with the chemicals, but also from the fumes generated. To that end protective outer garments, such as Tyvek® coveralls, full face powered air purifying respirators with eye protection and charcoal breathing filters, and protective gloves are recommended. In confined locations, additional safety measures such as negative air machines with charcoal filters are also recommended.

By using the four stage method of the present invention, it has been determined that a much more economical process for lead abatement has be developed. Whereas prior methods were only capable of overall production rate in the range of only twelve square feet of abatement per man hour, the method of the present invention is capable of abatement rates in the range of two hundred square feet of abatement per hour. This results in a substantial savings in labor and material costs. Additionally, it has been found that the present invention is capable of substantially eliminating the problem of lead migration into the substrate pores, thereby eliminating the necessity of further abatement treatment, or the alternative of having to top coat the treated substrate in order to confine the lead within the pores beneath the top coat. This is another substantial economic savings.

Furthermore, the processing system for treating and filtering the water collected from rinsing the chemicals from the surface substrate quickly and effectively treats the water making it acceptable for disposal within required governmental safety limits.

Without further elaboration, it is believed that the foregoing so fully illustrates the present invention that others may, by applying current or future knowledge, apply the same for use under various conditions of service.

Methods for treating lead-containing surface coatings and lead-contaminated soil are described above. Various details of the invention may be changed without departing from its scope. Furthermore, the foregoing description of the preferred embodiment of the invention and best mode for practicing the invention are provided for the purpose of illustration only and not for the purpose of limitation—the invention being defined by the claims.

1. A method for treating a lead-containing surface coating on a substrate, comprising the steps of:
(a) applying chemicals to the substrate in successive stages, said chemicals comprising glacial acetic acid, hydrogen peroxide, nitric acid, and ammonium hydroxide; and
(b) after application of the chemicals in step (a), allowing the chemicals to remain on the substrate for a thermochemical leaching period, whereby a resulting chemical reaction removes lead ions from the substrate.

2. A method according to claim 1, wherein the chemicals are applied by means selected from the group consisting of brushing, spraying, and dipping.

3. A method according to claim 1, and comprising allowing a chemical dwell time between each successive stage of chemical application to the substrate.

4. A method according to claim 3, wherein the dwell time is between 30 seconds and 3 minutes.

5. A method according to claim 1, wherein the concentration of glacial acetic acid is within a range of 99% to 175% v/v.

6. A method according to claim 1, wherein the concentration of hydrogen peroxide is within a range of 50% to 70% v/v.

7. A method according to claim 1, wherein the concentration of nitric acid is within a range of 68% to 85% v/v.

8. A method according to claim 1, wherein the concentration of ammonium hydroxide is within a range of 28% to 50% v/v.

9. A method according to claim 1, and comprising rinsing the chemicals from the substrate with water after the thermochemical leaching period.

10. A method according to claim 9, and comprising neutralizing the rinse water prior to disposal.

11. A method for treating a lead-containing surface coating on a substrate, comprising the steps of:
(a) applying chemicals to the substrate in successive stages, comprising a first stage application of glacial acetic acid, a second stage application of hydrogen peroxide, a third stage application of nitric acid, and a fourth stage application of ammonium hydroxide; and
(b) after application of the chemicals in step (a), allowing the chemicals to remain on the substrate for a thermochemical leaching period, whereby a resulting chemical reaction removes lead ions from the substrate.

12. A method for treating a lead-containing surface coating on a substrate, comprising the steps of:
(a) applying chemicals to the substrate in successive stages, comprising a first stage application of 99% to 175% v/v glacial acetic acid, a second stage application of 50% to 70% v/v hydrogen peroxide, a third stage application of 68% to 85% v/v nitric acid, and a fourth stage application of 28% to 50% v/v ammonium hydroxide;
(b) allowing a chemical dwell time of greater than 30 seconds between each successive stage of chemical application to the substrate;
(c) after application of the chemicals in step (a), allowing the chemicals to remain on the substrate for a thermochemical leaching period, whereby a resulting chemical reaction removes lead ions from the substrate; and
(d) after the thermochemical leaching period, rinsing the chemicals from the substrate with water.

13. A method for treating lead-contaminated soil, comprising the steps of:
(a) aerating the soil;
(b) applying chemicals to the aerated soil in successive stages, said chemicals comprising glacial acetic acid, hydrogen peroxide, nitric acid, and ammonium hydroxide; and
(c) after application of the chemicals in step (a), allowing the chemicals to remain on the soil for a thermochemical leaching period, whereby a resulting chemical reaction removes lead ions from the soil.

14. A method according to claim 13, wherein the concentration of glacial acetic acid is within a range of 99% to 175% v/v.

15. A method according to claim 13, wherein the concentration of hydrogen peroxide is within a range of 50% to 70% v/v.

16. A method according to claim 13, wherein the concentration of nitric acid is within a range of 68% to 85% v/v.

17. A method according to claim 13, wherein the concentration of ammonium hydroxide is within a range of 28% to 50% v/v.

18. A method according to claim 13, and comprising saturating the soil with water after the thermochemical leaching period.

19. A method for treating lead-contaminated soil, comprising the steps of:
(a) aerating the soil;
(b) applying chemicals to the aerated soil in successive stages, comprising a first stage application of glacial acetic acid, a second stage application of hydrogen peroxide, a third stage application of nitric acid, and a fourth stage application of ammonium hydroxide; and
(c) after application of the chemicals in step (a), allowing the chemicals to remain on the soil for a thermochemical leaching period, whereby a resulting chemical reaction removes lead ions from the soil.

20. A method for treating lead-contaminated soil, comprising the steps of:
(a) aerating the soil;
(b) applying chemicals to the aerated soil in successive stages, comprising a first stage application of 99% to 175% v/v glacial acetic acid, a second stage application of 50% to 70% v/v hydrogen peroxide, a third stage application of 68% to 85% v/v nitric acid, and a fourth stage application of 28% to 50% v/v ammonium hydroxide;
(b) allowing a chemical dwell time of greater than 30 seconds between each successive stage of chemical application to the soil;
(c) after application of the chemicals in step (a), allowing the chemicals to remain on the soil for a thermochemical leaching period, whereby a resulting chemical reaction removes lead ions from the soil; and
(d) after the thermochemical leaching period, saturating the soil with water.
